(19) United States
(12) Patent Application Publication
(10) Pub. No.: US 2015/0153037 A1
(43) Pub. Date: Jun. 4, 2015

(54) COMBINATION LED LAMP AND SPEAKERPHONE ASSEMBLY

(71) Applicants: Hsiang-Yu LEE, Taipei City (TW); Chia-Yu LEE, Taipei City (TW)

(72) Inventor: Chia-Yu LEE, Taipei City (TW)

(21) Appl. No.: 14/543,431

(22) Filed: Nov. 17, 2014

(30) Foreign Application Priority Data
Dec. 4, 2013 (TW) 102222777

(51) Int. Cl. F21V 33/00; F21V 23/06; H04R 1/02; F21V 29/77

(52) U.S. Cl. CPC F21V 33/0056; F21V 29/77; F21V 23/06; H04R 1/028; F21Y 2101/02

(57) ABSTRACT

A combination LED lamp and speakerphone assembly used in a LED lamp and sound amplification system and controllable a mobile electronic device through a signal sharing device to produce sound is disclosed to include a LED lamp body holding therein a power drive module, a heat sink and a LED module mounted on the LED lamp body, and a sound amplification device electrically coupled to the power drive module. A user can operate a mobile electronic device to provide a Bluetooth signal to the signal sharing device, enabling the Bluetooth signal to be converted into multiple electrical signals and then provided to the sound amplification devices of multiple combination LED lamp and speakerphone assemblies by the signal sharing device, causing the sound amplification devices to be driven to produce sound. Thus, the invention greatly enhances the added function and effects of LED lamps, allowing the user to create a personal musical environment.

This application claims the priority benefit of Taiwan patent application number 102222777, filed on Dec. 4, 2013.

### BACKGROUND OF THE INVENTION

1. Field of the Invention

The present invention relates to LED lighting technology and more particularly, to a combination LED lamp and speakerphone assembly for LED lamp and sound amplification device system, which comprises a LED lamp body, a heat sink mounted on the LED lamp body, a LED module supported on the heat sink and electrically connected to the LED lamp body, a power drive module mounted inside the LED lamp body, and a sound amplification device mounted in the LED lamp body and electrically connected to the power drive module and controllable by an external mobile electronic device through a signal sharing device to produce sound.

2. Description of the Related Art

Lamp acts an important role in our daily lives. It provides bright lighting and clear visibility, enabling night activities to be carried out smoothly. In addition to indoor lighting, lamp can also be used for outdoor light, vehicle light and advertising light applications. By means of different lighting modes, different designs of lamps can be used at night or in dark corners for illumination.

Regular fluorescent tubes commonly use electricity to excite mercury vapor, causing excited mercury atoms to produce short-wave ultraviolet light that then causes a phosphor to fluoresce, producing visible light in a particular color temperature subject to the nature of the phosphor applied. However, fluorescent tubes have the disadvantages of fast attenuation of light, high consumption of power, high initial cost, being subject to flickering and short lifespan. In response to demands for environmental protection and energy saving, LED-based lighting fixtures are created. Nowadays, LED bulbs are intensively used in embedded light, head light, desk lamp and other lighting fixtures to substitute for conventional fluorescent tubes for the advantages of energy-saving, constant wavelength, light volume and quality adjustability, compact size, low heat generation and long lifespan.

Various LED downlights, LED headlights and LED desk lights are commercially available. A conventional LED lamp generally comprises a lamp holder, a power drive module mounted in the lamp holder, a heat sink with radiation fins arranged around the lamp holder, and a circuit board mounted on the heat sink to hold a light-emitting module. Through the lamp holder, the power drive module can obtain the necessary working power supply from an external power source for driving the light-emitting module to emit light. During operation of the light-emitting module, generated waste heat is transferred by the heat sink to the radiation fins for dissipation into the air.

However, conventional LED lamps can simply be used to substitute for conventional lamps for illumination without giving any added functions. With the modern quest for continuous product creativity and inspiration, any thoughtful design conducive to consumers can play a pivotal role in the industry and affect the sales and market share. Therefore, there is a strong demand for LED lamps having added functions.

### SUMMARY OF THE INVENTION

The present invention has been accomplished under the circumstances in view. It is therefore the main object of the present invention to provide a combination LED lamp and speakerphone assembly used in a LED lamp and sound amplification system and controllable a mobile electronic device through a signal sharing device to produce sound. The combination LED lamp and speakerphone assembly comprises an LED lamp body, a heat sink mounted on the LED lamp body, a LED module mounted on the heat sink and electrically connected to the LED lamp body for emitting light, and sound amplification device electrically connected to a power drive module of the LED lamp body. The sound amplification device comprises a signal receiver module adapted for receiving an electrical signal from the signal sharing device, a control module electrically coupled with the signal receiver module and adapted for converting the electrical signal into a control signal, and a sound amplification unit controllable by the control signal to output sound. When the user clicks a physical button of the mobile electronic device or a virtual button on the touchscreen of the mobile electronic device, a Bluetooth signal is outputted by the mobile electronic device to the signal sharing device and then converted by the signal sharing device into multiple electrical signals that are than provided by the signal sharing device to the signal receiver modules of the sound amplification devices in the LED lamp bodies of multiple combination LED lamp and speakerphone assemblies, and then respectively converted into a control signal by respective control modules of the respective sound amplification devices of the respective combination LED lamp and speakerphone assemblies for driving the respective sound amplification units of the respective sound amplification devices of the respective combination LED lamp and speakerphone assemblies to produce sound, thereby creating a personal musical environment.

### BRIEF DESCRIPTION OF THE DRAWINGS

FIG. 1 is an oblique top elevational view of a LED lamp of a wireless LED lamp and sound amplification system in accordance with the present invention.

FIG. 2 is an exploded view of the LED lamp shown in FIG. 1.

FIG. 3 is a sectional side view of the LED lamp shown in FIG. 1.

FIG. 4 is a system block diagram of the LED lamp and sound amplification system in accordance with the present invention.

FIG. 5 is an oblique top elevational view of the sound amplification device of the combination LED lamp and speakerphone assembly in accordance with the present invention.

FIG. 6 is an exploded view of the sound amplification device shown in FIG. 5.

FIG. 7 is a schematic applied view of the present invention, illustrating an application status of the LED lamp and sound amplification device system.

### DETAILED DESCRIPTION OF THE PREFERRED EMBODIMENT

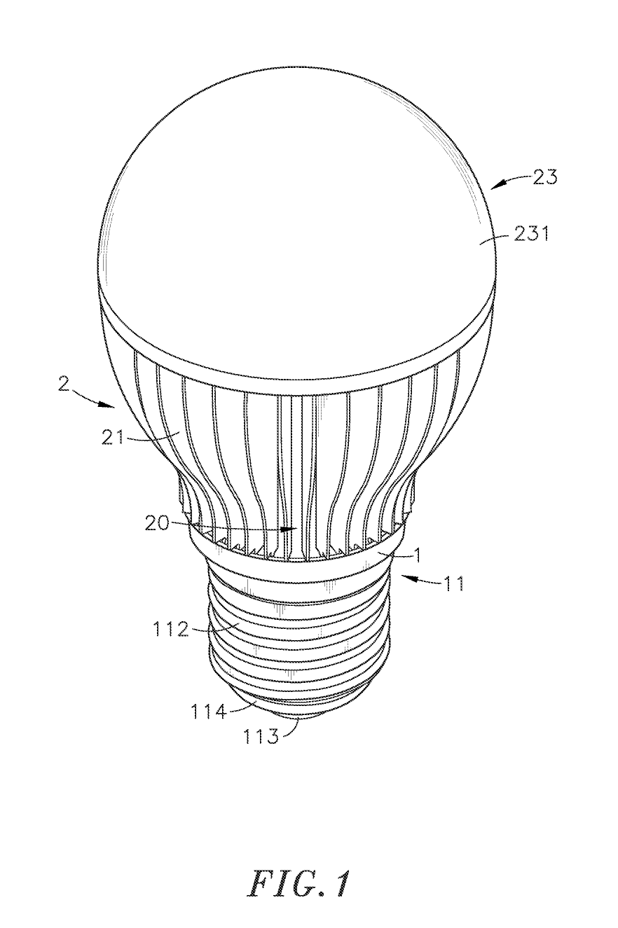

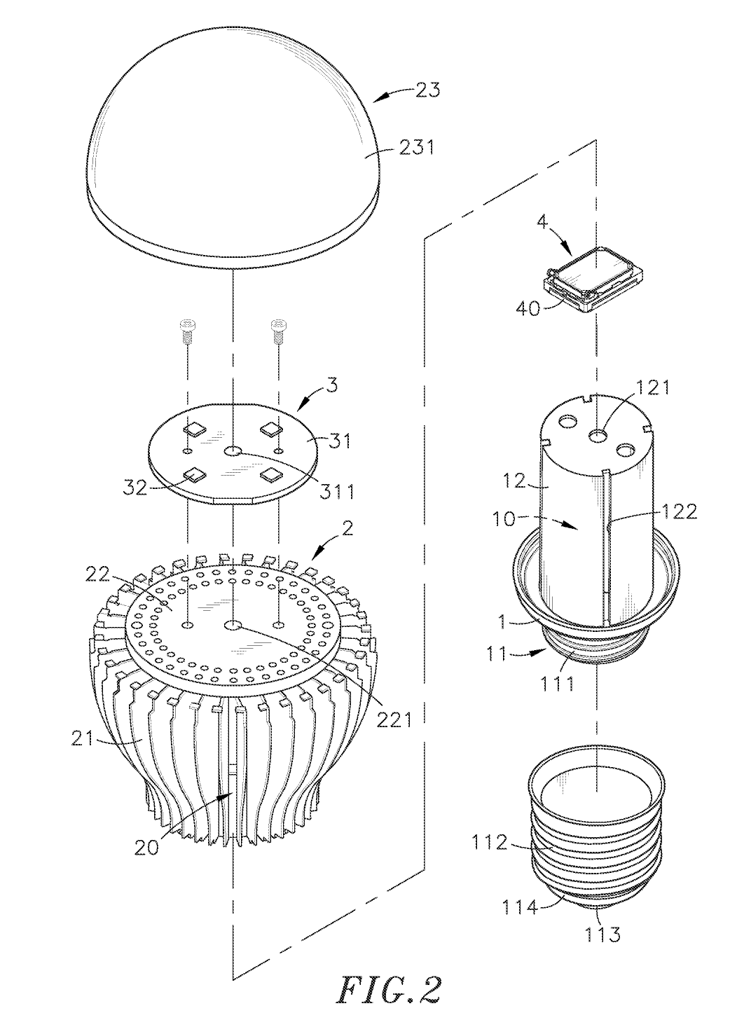

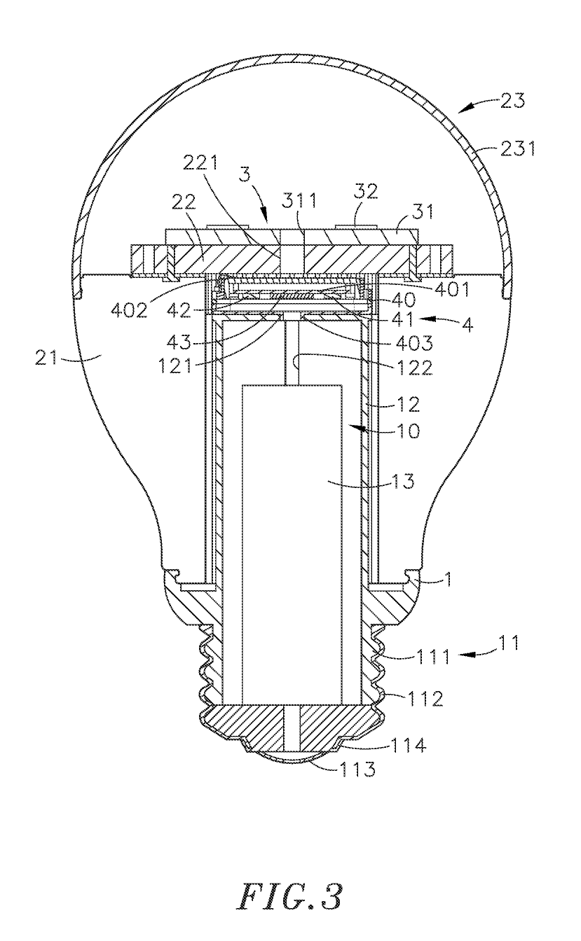

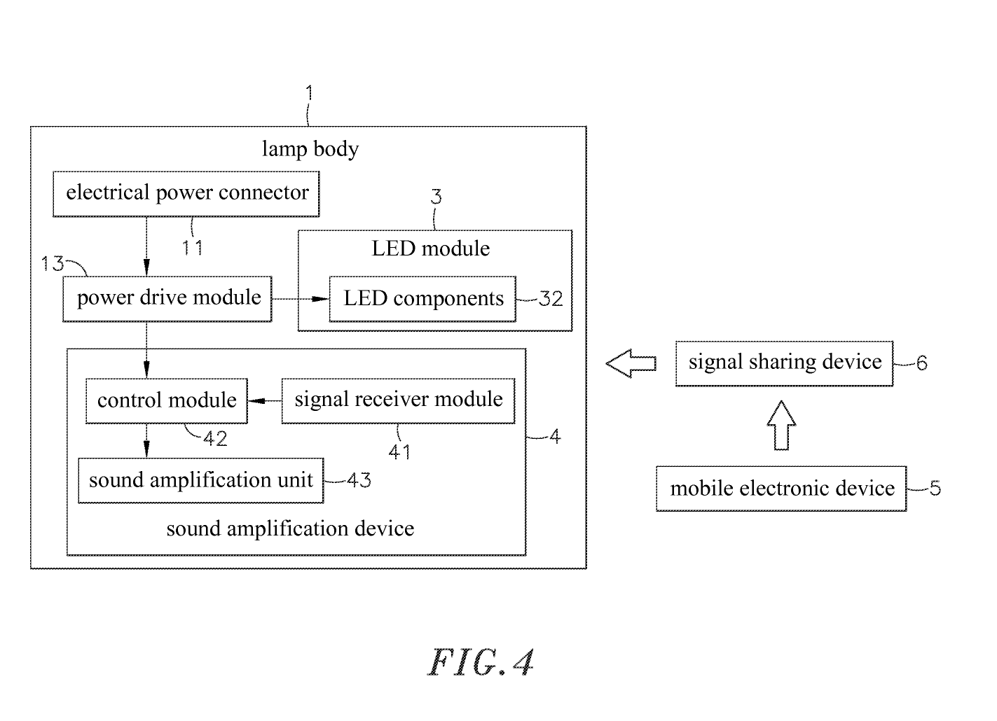

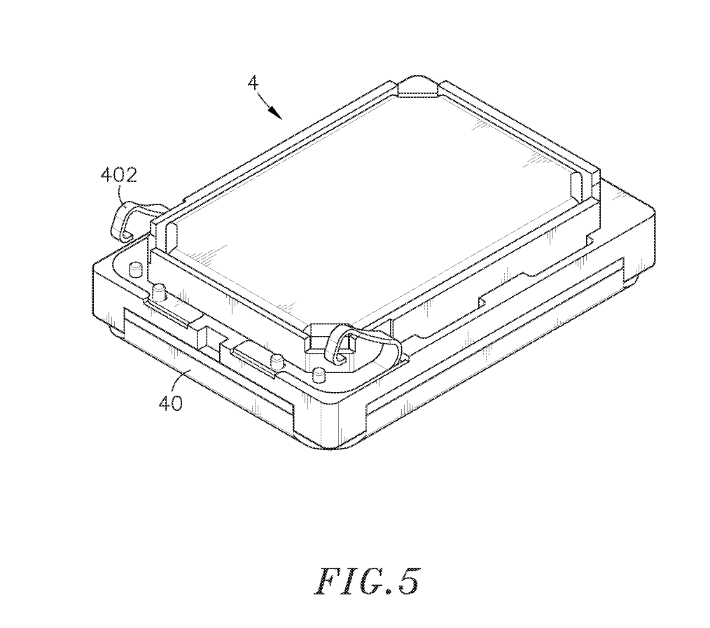

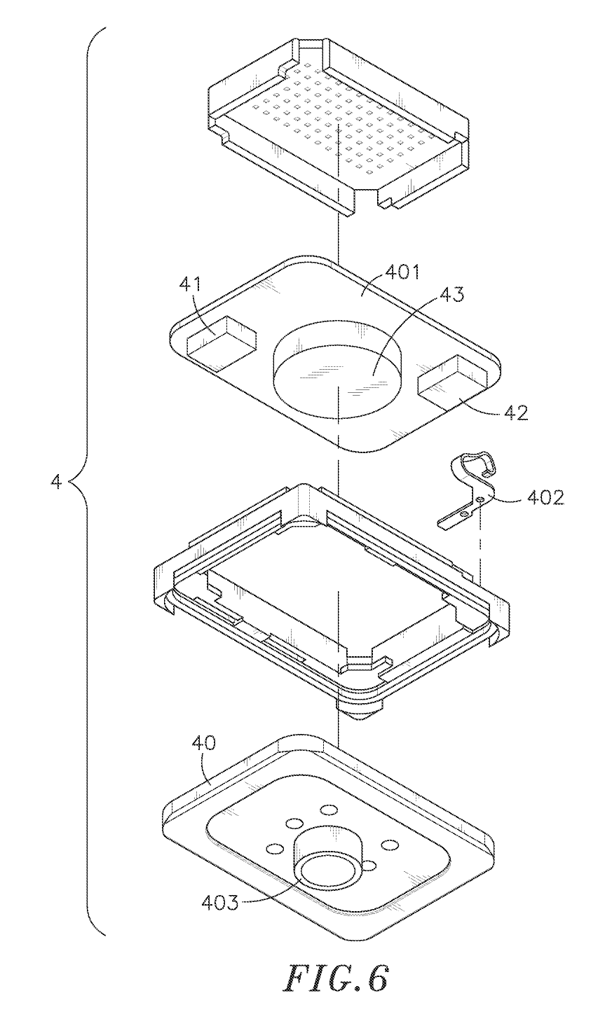

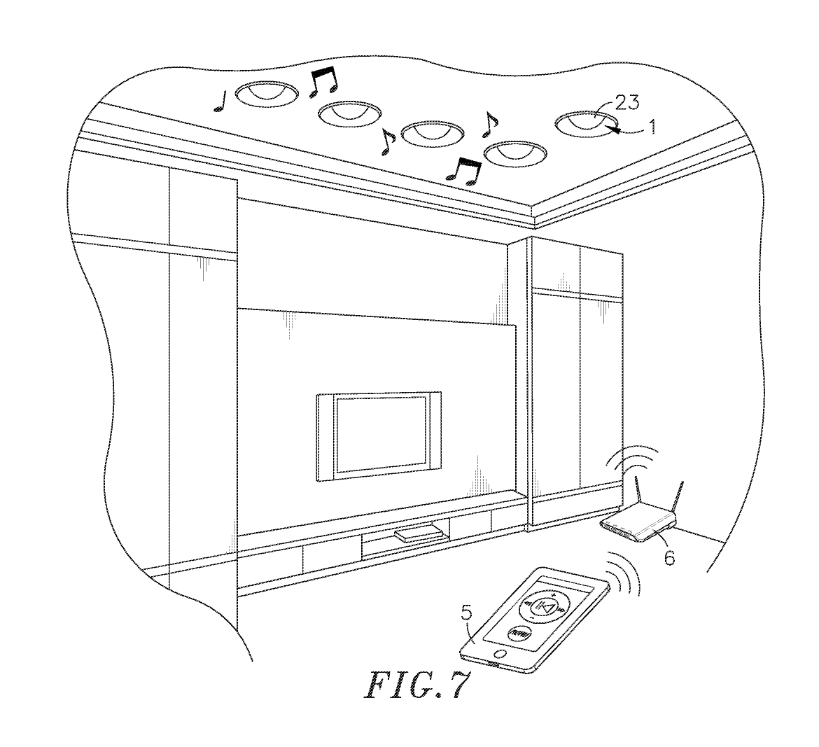

Referring to FIGS. 1-7, a combination LED lamp and speakerphone assembly in accordance with the present invention is shown used in a LED lamp and sound amplification system and controllable a mobile electronic device 5 through a signal sharing device 6 to produce sound. The combination LED lamp and speakerphone assembly comprises an LED lamp body 1, a heat sink 2, a LED module 3, and a sound amplification device 4.

The LED lamp body 1 comprises a male electrical power connector 11 located at a bottom side thereof and electrically connectable to a mating female electrical power connector (not shown). In this embodiment, the electrical power connector 11 is a thread-connection design for threading into a lamp socket. However, this thread-connection design is not a limitation. Alternatively, the male electrical power connector 11 can be a plug design for connection to an electrical socket. The electrical power connector 11 comprises a thread-connection base 111, a ring contact 112 configured to fit the configuration of the threaded periphery of the thread-connection base 111 and fixedly covered on the periphery of the thread-connection base 111, a tip contact 113 located at the center of the bottom side of the thread-connection base 111, and an insulation 114 set between the ring contact 112 and the tip contact 113.

The LED lamp body 1 further comprises a hollow cylindrical member 12 located at a top side of the male electrical power connector 11, an accommodation chamber 10 defined in the hollow cylindrical member 12, and a power drive module 13 mounted in the accommodation chamber 10 and electrically coupled with the electrical power connector 11. The hollow cylindrical member 12 has at least one through hole 121 located in a top wall thereof for the mounting of electrical wires and other related electronic components of the power drive module 13 such as rectifier, driver, and etc, and a plurality of longitudinal slots 122 spaced around the periphery thereof. With respect to how the power drive module 13 is electrically connected to the lamp socket through the electrical power connector 11 and how the power drive module 13 uses the rectifier or driver to convert AC power into the desired DC power, these objects can easily be achieved using the known techniques. Therefore, no further detailed description in this regard will be necessary.

The heat sink 2 comprises a plurality of radiation fins 21 radially arranged around a circle, a mounting chamber 20 surrounded by the radiation fin 21 for receiving the hollow cylindrical member 12 of the LED lamp body 1, a heat transfer plate 22 fixedly fastened to the radiation fins 21 at a top side above the LED lamp body 1 with rivets or screws, or using a bonding technique, and a lampshade 23 affixed to the radiation fins 21 or heat transfer plate 22 and covered over the heat transfer plate 22. The lampshade 23 has at least one light-transmitting portion 231 that admits light. Further, the lampshade 23 can be made of transmissive or translucent in any of a variety of colors. Further, the lampshade 23 is not a requisite component, and can be emitted.

The LED module 3 comprises a circuit board 31 having a center through hole 311 and affixed to the heat transfer plate 22 of the heat sink 2, and a plurality of LED components 32 mounted at the circuit board 31 and respectively aimed at the light-transmitting portion 231 of the lampshade 23. Further, the circuit board 31 is selected from the group of aluminum substrate, copper substrate, ceramic substrate, and honeycomb ceramic substrate (HCS). In this embodiment, the LED components 32 are equiangularly spaced around the center through hole 311 of the circuit board 31. Further, the LED components 32 can be high power LED chips, low power LED chips, or high brightness light-emitting diodes of different colors, and bonded to the circuit board 31 using SMT or through-hole technology hole. Further, the LED lamp body 1, the heat sink 2 and the LED module 3 can be configured and assembled to form an LED lamp bulb, an LED downlight, an LED spot light, an LED track light, an LED landscape light, or an LED emergency light.

The sound amplification device 4 is disposed in between the hollow cylindrical member 12 of the LED lamp body 1 and the mounting chamber 20 of the heat sink 2. Alternatively, the sound amplification device 4 can be directly installed in the LED lamp body 1, the heat sink 2, or the circuit board 31 of the LED module 3 without blocking the light of the LED components 32. The sound amplification device 4 comprises a body shell 40, a circuit board 401 mounted inside the body shell 40, and a signal receiver module 41 mounted in the circuit board 401 and adapted for receiving a Bluetooth signal from the mobile electronic device 5 through the signal sharing device 6 and converting the Bluetooth signal into a control signal, a control module 42 mounted in the circuit board 401 and adapted for receiving the control signal from the signal receiver module 41, and a sound amplification unit 43 mounted in the circuit board 401 and controllable by the control module 42 to output sound. Further, the signal receiver module 41 can be a RF receiver module, Wi-Fi receiver module, ZigBee receiver module, or any other wireless transmission interface means that support the 2.5 GHz band. Further, the body shell 40 is preferably formed of a bottom shell member and a top cover shell member. Further, a plurality of electric contacts 402 are mounted inside the body shell 40. If the sound amplification device 4 is mounted between the LED lamp body 1 and the heat sink 2, the electric contacts 402 can be bonded to the circuit board 401 directly or by means of electrical wires. If the sound amplification device 4 is disposed outside the LED lamp body 1, the electric contacts 402 can be electrically connected to the circuit board 401 using electrical wires. Further, the body shell 40 has a stub tube 403 located at a bottom side thereof and press-fitted into the through hole 121 of the hollow cylindrical member 12.

Further, the power drive module 13 of the LED lamp body 1 is electrically connected with the ring contact 112 and tip contact 113 of the electrical power connector 11 by respective electrical wires that are inserted through the through hole 121 at the center of the top side of the hollow cylindrical member 12 and the through hole 221 of the heat transfer plate 22. Alternatively, the electrical wires can be inserted through the center through hole 311 of the circuit board 31 of the LED module 3 to electrically connect the power drive module 13 of the LED lamp body 1 to the circuit board 31 and the electric contacts 402 in the body shell 40 of the sound amplification device 4, enabling the sound amplification device 4 and the LED module 3 to obtain the necessary working power. As different types and modules of LED lamps can be used in the present invention, the electrical wiring can be changed without departing from the spirit and scope of the present invention.

Further, the mobile electronic device 5 can be a computer, smart phone, tablet computer, or notebook computer, having built therein a Bluetooth transmission module. By means of operating a physical button, or a virtual button (such as Remote) of an application software shown on the touchscreen (not shown) of the mobile electronic device 5, the mobile electronic device 5 is driven to output a Bluetooth signal.

The signal sharing device 6 can be a wireless network sharing device, an Access Point or Wireless Access Point, a router, a wireless network router, or any other signal sharing design capable of converting a Bluetooth signal into multiple 2.4 GHz electrical signals.

In installation, connect the electrical power connector 11 of the LED lamp body 1 to a mating lamp socket (not shown) to electrically connect the ring contact 112 and the tip contact 113 to the positive terminal and negative terminal of the mating lamp socket, enabling the LED components 32 at the circuit board 31 of the LED module 3 to be driven by the power drive module 13 to emit light toward the at least one light-transmitting portion 231 of the lampshade 23. Further, the lampshade 23 can be a light-transmitting lampshade that admits light. Alternatively, the lampshade 23 can be reflector type lampshade to reflect light toward a predetermined direction. During operation of the LED module 3, heat produced by the LED components 32 can be transferred by the heat transfer plate 22 of the heat sink 2 to the radiation fins 21 for quick dissipation into the air. It is to be understood that in the LED lamp and sound amplification device system, a user can operate the mobile electronic device 5 to control multiple combination LED lamp and speakerphone assemblies to produce sound, wherein the electrical power connectors 11 of the LED lamp bodies 1 of the multiple combination LED lamp and speakerphone assemblies are respectively connected to respective mating lamp sockets.

In application, the user can click the physical button or a virtual button on the touchscreen of the mobile electronic device 5 to produce an electrical signal (sound source signal), enabling the electrical signal to be converted into a Bluetooth signal and transmitted to the signal sharing device 6 by the built-in wireless transmission module of the mobile electronic device 5. At this time, the signal sharing device 6 converts the Bluetooth signal into multiple electrical signals and provide these electrical signals to the signal receiver modules 41 of the sound amplification devices 4 in the respective LED lamp bodies 1 of the multiple combination LED lamp and sound amplification device assemblies, causing the respective control modules 42 to drive the respective sound amplification units 43 to output sound. Further, the mobile electronic device 5 can be controlled to regulate the volume of the output sound of the sound amplification devices 4 in the respective LED lamp bodies 1 of the multiple combination LED lamp and sound amplification device assemblies. The invention combines an LED lamp body 1, a heat sink 2, a LED module 3 and a sound amplification device 4 into a combination LED lamp and speakerphone assembly for emitting light and producing sound. Thus, a user can operate a mobile electronic device 5 to control the operation of multiple combination LED lamp and speakerphone assemblies through the signal sharing device 6, creating a personal musical environment. The invention allows a user to operate a mobile electronic device 5 in controlling multiple combination LED lamp and speakerphone assemblies to produce music in a remote manner, and the user can create a personal musical environment without the need of moving the body to the front side of a radio, stereo system or audio player and then operating the face panel of the radio, stereo system or audio player. The invention greatly enhances the added function and effects of LED lamps.

Further, the sound amplification unit 43 of the sound amplification device 4 is this embodiment is a speaker. The mobile electronic device 5 is operable to output a Bluetooth signal (for example, sound source signal) to the signal sharing device 6 that converts the Bluetooth signal into multiple electrical signals and providing these electrical signals to the signal receiver modules 41 of the sound amplification devices 4 of respective combination LED lamp and speakerphone assemblies.

The stub tube 403 at the bottom side of the body shell 40 of the sound amplification device 4 of each combination LED lamp and speakerphone assembly is press-fitted into the through hole 121 of the hollow cylindrical member 12 of the respective LED lamp body 1 so that the sound outputted by the associating sound amplification unit 43 can go through the stub tube 403 into the inside of the hollow cylindrical member 12 where a resonance effect is produced to enhance the sound, enabling the sound waves to be delivered to the outside open air through the longitudinal slots 122 of the hollow cylindrical member 12 and the gaps in between the radiation fins 21 of the heat sink 2. Thus, the user can listen to the music being outputted by the sound amplification device 4 of each combination LED lamp and speakerphone assembly at a distance. Thus, a surrounding sound effect can be created by controlling multiple combination LED lamp and speakerphone assemblies to produce music in a remote manner.

In conclusion, the invention combines a LED lamp body 1, a heat sink 2, a LED module 3 and a sound amplification device 4 into a combination LED lamp and speakerphone assembly for use in a LED lamp and sound amplification system. The sound amplification device 4 is electrically connected to a power drive module 13 in the LED lamp body 1, comprising a signal receiver module 41, a control module 42 and a sound amplification unit 43. When the user clicks a physical button of a mobile electronic device 5, or a virtual button of on the touchscreen of the mobile electronic device 5, the mobile electronic device 5 is driven to output a Bluetooth signal to a signal sharing device 6 that converts the Bluetooth signal into multiple electric signals and provides these electrical signals to the signal receiver modules 41 of the sound amplification devices 4 of multiple combination LED lamp and speakerphone assemblies, enabling the electrical signals to be converted into a control signal by the control modules 42 of the respective combination LED lamp and speakerphone assemblies to drive the respective sound amplification units 43 of the respective combination LED lamp and speakerphone assemblies to produce sound synchronously. This operation is direct and convenient, enhancing the added function and effects of LED lamps.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A combination LED lamp and speakerphone assembly used in a LED lamp and sound amplification system and controllable a mobile electronic device through a signal sharing device to produce sound, said combination LED lamp and speakerphone assembly comprising an LED lamp body, a heat sink mounted on said LED lamp body, a LED module mounted on said heat sink and electrically connected to said LED lamp body for emitting light, said LED lamp body comprising an electrical power connector electrically connectable to an external mating electrical power connector for power input, a power drive module electrically connected with said electrical power connector and said LED module and adapted for driving said LED module to emit light, the combination LED lamp and speakerphone assembly further comprising a sound amplification device electrically connected to said power drive module of said LED lamp body, said sound amplification device comprising a signal receiver module adapted for receiving an electrical signal from said signal sharing device, a control module electrically coupled with said signal receiver module and adapted for converting said electrical signal into a control signal, and a sound amplification unit controllable by said control signal to output sound.

2. The combination LED lamp and speakerphone assembly as claimed in claim 1, wherein said electrical power connector of said LED lamp body comprises a thread-connection base, a ring contact mounted around the periphery of said thread-connection base, a tip contact located at a bottom side of said thread-connection base, and an insulation mounted at said thread-connection base between said ring contact and said tip contact; said LED lamp body comprises a hollow cylindrical member defining therein an accommodation chamber for accommodating said power drive module.

3. The combination LED lamp and speakerphone assembly as claimed in claim 2, wherein said heat sink comprises a plurality of radiation fins radially arranged around a circle, a hollow cylindrical chamber surrounded by said radiation fins for receiving said LED lamp body, and a heat transfer plate mounted on said radiation fins at a top side.

4. The combination LED lamp and speakerphone assembly as claimed in claim 3, wherein said LED module comprises a circuit board supported on said heat transfer plate of said heat sink, and at least one LED component mounted on a top side of said circuit board opposite to said heat sink.

5. The combination LED lamp and speakerphone assembly as claimed in claim 1, further comprising a lampshade mounted on said heat sink and covered over said LED module.

6. The combination LED lamp and speakerphone assembly as claimed in claim 1, wherein said sound amplification device further comprises a body shell, a circuit board mounted in said body shell and electrically connected with said signal receiver module, said control module and said sound amplification unit, and a plurality of electric contacts mounted in said body shell and electrically connecting the circuit board of said sound amplification device to said power drive module.

7. The combination LED lamp and speakerphone assembly as claimed in claim 1, wherein said signal receiver module of said sound amplification device is a radio-frequency receiver module, a Wi-Fi receiver module, a ZigBee receiver module, or a wireless transmission interface means that support the 2.5 GHz band.

8. The combination LED lamp and speakerphone assembly as claimed in claim 1, wherein said mobile electronic device is a computer, smart phone, tablet computer or notebook computer, having a physical button or application software operable to output a Bluetooth signal.

9. The combination LED lamp and speakerphone assembly as claimed in claim 1, wherein said signal sharing device is a wireless network sharing devices, an Access Point or Wireless Access Point, a router, or a wireless network router.
